(19) United States
(12) Patent Application Publication
(10) Pub. No.: US 2010/0005299 A1
(43) Pub. Date: Jan. 7, 2010

(54) METHOD FOR MANUFACTURING A PRODUCT, SYSTEM FOR MANUFACTURING A PRODUCT, AND PRODUCT

(76) Inventor: IKURO IWASE, KANAGAWA (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/166,330

(22) Filed: Jul. 2, 2008

Related U.S. Application Data
(63) Continuation of application No. PCT/JP2008/056442, filed on Mar. 31, 2008.

(30) Foreign Application Priority Data
Mar. 31, 2008 (JP) PCT/JP2008/056442

(51) Int. Cl. H04L 9/32; H04L 9/28; G06F 19/00

(52) U.S. Cl. 713/170; 380/28; 700/117; 715/742

(57) ABSTRACT

Provided is a product on which is imprinted an encrypted message obtained by encrypting a message sent along with the product from a sender to a recipient, a method for manufacturing the product, and a system for manufacturing the product. The product manufacturing system has a general web server, an encryption calculating apparatus, an issued encryption values database, a specialized web server, an archive database, and an imprinting apparatus. The product manufacturing system is provided with a message acquiring section that acquires the original message sent along with the product from the sender to the recipient, an encryption calculating apparatus that generates a calculated encryption value by using a hash function to compress a calculation target message extracted from the original message, and an imprinting control section that controls imprinting of the calculated encryption value onto the product.

### CROSS REFERENCE TO RELATED APPLICATION

This is a continuation application of PCT/JP2008/056442 filed on Mar. 31, 2008, the contents of which are incorporated herein by reference.

### BACKGROUND

1. Technical Field

The present invention relates to a method for manufacturing a product, a system for manufacturing a product, and a product. In particular, the present invention relates to a product on which is imprinted an encrypted message obtained by encrypting a message given from a sender to a recipient sent along with the product, a method for manufacturing the product, and a system for manufacturing the product. The present invention further relates to a product having an associated message that can be authenticated by involved parties by matching an imprinted encryption value to a calculated encryption value via a communication network, a method for manufacturing the product, and a system for manufacturing the product.

2. Related Art

When a sender attaches a message to a product given to a recipient, the sender records the message on a medium such as a gift card, a letter, or an e-mail, which is separate from the product, and sends both to the recipient. If the sender does not record the message on such a medium, he/she may directly communicate the message by speaking to the recipient. Japanese Patent Application Publication No. 2003-288424 discloses a technique for sending an encrypted message from the sender to the recipient and for decrypting the message after the recipient receives the message.

The medium on which the message is recorded, however, has low durability compared to the product. For example, the message medium is less durable than a product that is made from precious metal. The message medium therefore has a shorter lifespan than the product. If the message medium is lost or damaged, the message that the sender wishes to communicate through the gift is unlikely to remain with the recipient for a long time. It is also difficult for the message medium to be passed down from generation to generation along with the durable product.

Since the message associated with the product is recorded on a separate medium, the effect that the message of the sender has on the recipient gradually fades, and may even be forgotten in extreme cases.

By imprinting the message itself on the product, the message can remain close to the recipient. But since there is limited space for imprinting on the product, there is a restriction on how much can be recorded. Due to this restriction, the sender is limited to imprinting a short message that cannot express all of his/her wishes.

If the sender wishes to keep the message private, he/she will avoid imprinting the message directly onto the product.

If the product is lost and then found by a third party and returned to the retailer, it is difficult for the retailer to identify the sender and/or recipient.

### SUMMARY

Therefore, it is an object of an aspect of the innovations herein to provide a product manufacturing method, a product manufacturing system, and a product, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary manufacturing method may include a method for manufacturing a product that includes the steps of acquiring the original message given from the sender to the recipient, setting at least a portion of the original message to be a calculation target message and acquiring a calculated encryption value by compressing the calculation target message with a hash function specific to each retailer, and imprinting the calculated encryption value onto the product as an imprinted encryption value.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a schematic view showing a configuration of a network connecting a product sender, a product recipient, a product inheritor, and a retailer containing a product manufacturing system.

FIG. 2 is a block diagram showing an internal configuration of the product manufacturing system 100.

FIG. 3 is a schematic view showing the product which has the imprinted encryption value.

FIG. 4 is a flow chart of the process by which the imprinted encryption value is imprinted on the product.

FIG. 5 is a schematic view showing generation of the encryption value from the calculation target message.

FIG. 6 shows an example of the calculation target message.

FIG. 7 shows an example in which the blanks in the text of the calculation target message are changed.

FIG. 8 shows an example of the return message sent from the recipient to the sender.

FIG. 9 shows an example of a process performed by the encryption calculating apparatus 30 when encrypting files having file-types different from each other.

FIG. 10 shows an exemplary display screen for displaying the private webpage or the inheritance webpage.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

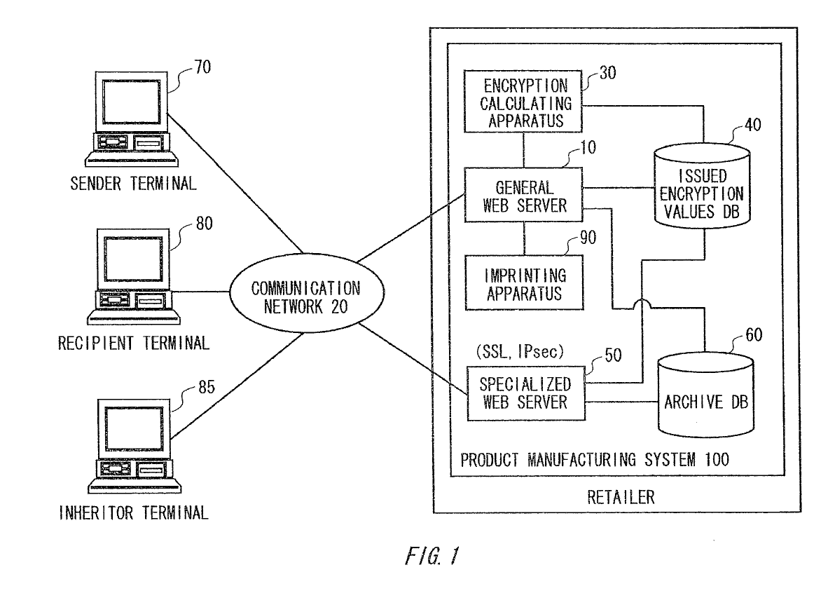

FIG. 1 is a schematic view showing a configuration of a network connecting a product sender, a product recipient, a product inheritor, and a retailer containing a product manufacturing system. The retailer has a product manufacturing system 100 that encrypts at least a portion of an original message and imprints the encrypted message onto the product. The product manufacturing system 100 is connected to a sender terminal 70, a recipient terminal 80, and an inheritor terminal 85 via a communication network 20.

The product manufacturing system 100 has a general web server 10, an encryption calculating apparatus 30, an issued encryption values database 40, a specialized web server 50, an archive database 60, and an imprinting apparatus 90. The general web server 10 is managed on the communication network 20 by the retailer. The sender terminal 70 sends an e-mail and the like to the general web server 10 of the retailer that includes information indicating the original message associated with the product and information indicating the product selected by the sender from among the products recorded in the general web server 10 onto which can be imprinted an encrypted and compressed message.

The encryption calculating apparatus 30 is managed by the retailer and encodes the message with function calculations specific to each retailer. The encryption calculating apparatus 30 encrypts and compresses all or a portion of the original message associated with the gift, and generates a calculated encryption value 2400. The issued encryption values database 40 stores the calculated encryption value imprinted as the imprinted encryption value 3010 and the customer information about the sender and the recipient, such as a name and address.

The imprinting apparatus 90 imprints the generated calculated encryption value 2400 onto the product as the imprinted encryption value 3010. The product manufacturing system 100 records at least the original message sent from the sender terminal 70 and information identifying a calculation target message 2000 in the electronic medium 3100. The electronic medium 3100 and the product 3000 onto which the imprinted encryption value 3010 is imprinted can be sent to the recipient.

The product is desirably a very durable product such as precious metal goods, jewelry, a watch, durable furniture, a carving, and the like. The original message that is attached to the product and presented from the sender to the recipient or the original message that the sender wants to share with a limited number of people, such as a couple getting engaged or married, is digitized by the sender terminal 70. If the sender brings the original message to the retailer, the product manufacturing system 100 digitizes the original message.

The encryption calculating apparatus 30 performs retailer specific encryption calculations on at least a portion of the original message acquired from the sender that is set as the calculation target message 2000, and compresses the message to a size that can be imprinted on the product. The imprinting apparatus 90 imprints the encryption value on the product with a unique encryption value generated by the retailer. The sender provides the product to the recipient or to a limited group such as a couple getting engaged or married.

The recipient terminal 80 sends a confirming message, which is input by the recipient, to the general web server 10. The general web server 10 sends the confirming message to the encryption calculating apparatus 30. The general web server 10 outputs a confirming calculated encryption value, which is generated by the encryption calculating apparatus 30 based on the confirming message, to the recipient terminal 80. The recipient verifies that the confirming calculated encryption value output by the recipient terminal 80 is the same as the imprinted encryption value imprinted on the product. By doing this, the recipient knows that the genuine calculation target message sent from the sender is encrypted, based on the imprinted encryption value.

The archive database 60 stores the imprinted encryption value as a portion of an access key, the original message sent from the sender to the recipient, a calculation target message identifier, identification information concerning people who are allowed access, long term archiving data, and a storing period. The specialized web server 50 receives the access authentication request from the sender terminal 70, the recipient terminal 80, or the inheritor terminal 85 to access a private webpage or an inheritance webpage. If the specialized web server 50 judges that the access authentication code is correct, the specialized web server 50 acquires the information stored in the archive database 60 corresponding to the access authentication. The specialized web server 50 creates the private webpage or the inheritance webpage that contains the information stored in the archive database 60. The specialized web server 50 provides the private webpage or the inheritance webpage to the sender terminal 70, the recipient terminal 80, or the inheritor terminal 85 that requested the access authentication.

The impression caused by the message associated with the gift does not disappear and remains with the gift for ages. In comparison with an original message imprinted directly onto the product, the method described above allows an original message with a greater amount of information. Therefore, the original message associated with the product can be highly descriptive. In addition to text, the original message associated with the product can also include sound, images, photographs, videos, and the like.

Furthermore, the message remains private between the sender and the recipient and cannot be read by a third party. This is because the third party cannot decrypt the original message from the imprinted encryption values on the gift. Therefore, only the involved parties can understand the message, which increases the value of the gift among the selected people because of the psychological effect of sharing a common secret.

Furthermore, since imprinting the original message on the gift as the imprinted encryption value gives the recipient a feeling that the message is always close by, the original message that the sender wants to communicate remains deep in the heart of the recipient for a long time. Therefore, the objective of giving the gift, which is for the sender to communicate his/her feeling to the recipient, is effectively achieved, thereby increasing the value of the product. Particularly if the product is something that the recipient wears every day such as a ring, a pendant, or a belt buckle, the recipient strongly feels the original message from the sender every day.

The retailer can use a calculation routine that is unique to the retailer and that uses a hash function. The retailer can further use a different calculation routine for each day that a gift is given to specify the time that the gift was given, thereby adding special meaning to the gift in the eyes of the involved parties and the inheritor of the product. In this way, the website through which the sender and the recipient can match the imprinted encryption value and the calculated encryption value of the message is strictly limited to the website of the retailer. In this way, the retailer can retain customers and maintain a trusting relationship with customers who hope that the retailer remains in business for ages. Even if the sender and the recipient become unable to contact each other against their wishes, such as by losing a portion of the access key, the information concerning the sender and recipient registered in the product manufacturing system 100 of the retailer based on the imprinted encryption value can be used to provide the lost portion of the access key, with the consent of the involved parties.

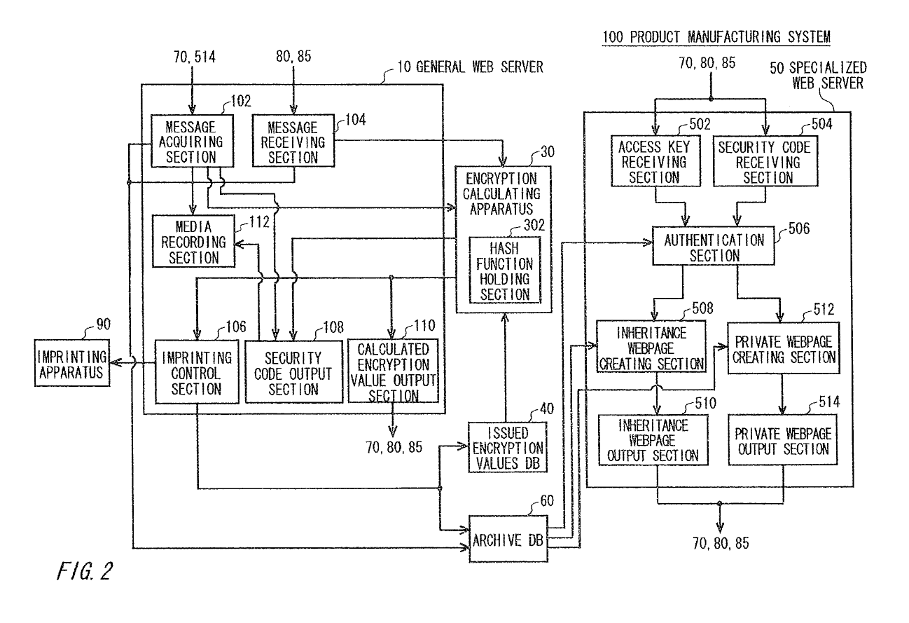

FIG. 2 is a block diagram showing an internal configuration of the product manufacturing system 100. The general web server 10 has a message acquiring section 102, a message receiving section 104, an imprinting control section 106, a security code output section 108, a calculated encryption value output section 110, and a media recording section 112. The encryption calculating apparatus 30 has a hash function holding section 302. The specialized web server 50 has an access key receiving section 502, a security code receiving section 504, an authentication section 506, an inheritance webpage creating section 508, an inheritance webpage output section 510, a private webpage creating section 512, and a private webpage output section 514.

The message acquiring section 102 acquires the original message sent along with the product from the sender to the recipient. For example, the message acquiring section 102 desirably acquires at least a character string included in the original message. The message acquiring section 102 acquires information from the sender selecting whether the original message is to be stored in the archive database 60 or not. When the message acquiring section 102 acquires a request for selecting storage, the message acquiring section 102 archives the original message in the archive database 60.

If the message acquiring section 102 acquires information that a person whose access has been authenticated on the private webpage or the inheritance webpage desires long-term archiving, the message acquiring section 102 archives the data and authentication information of the people, who are allowed to access the archive database 60. In other words, the message acquiring section 102 acquires information selecting the allowance of access to the private webpage or the inheritance webpage from the sender terminal 70. The archive database 60 archives a diary, a literary work, a family saying, a family tree, a voice message, a family photograph, an image, a video, and the like.

The encryption calculating apparatus 30 compresses the calculation target message with hash functions to generate the calculated encryption value. The hash function holding section 302 holds hash functions and functions that convert a calculated hash value, which are specific to the retailer. The encryption calculating apparatus 30 may generate a hash value conversion function that is different for each day that a product is given, and store these hash value conversion functions in the hash function holding section 302.

The encryption calculating apparatus 30 references the imprinted encryption values that have been issued and that are stored in the issued encryption values database 40. If an issued imprinted encryption value exists that is the same as the calculated encryption value generated based on the calculation target message, the encryption calculating apparatus 30 changes the position of the blanks or adds/subtracts blanks included in the text of the calculation target message. By generating a different final calculation target message without changing the character string aside from the blanks, the encryption calculating apparatus 30 generates a unique final calculated encryption value that does not exist in the issued encryption values database 40.

The retailer can set all of the imprinted encryption values issued from the retailer to be unique values. By doing this, the sender and the recipient feel that the imprinted encryption value of the product is the only one of its kind from among the products of the retailer. The retailer can identify the sender and the recipient based on the encryption value imprinted on the product. Accordingly, if the recipient loses the product, someone who finds the product can contact the retailer and the retailer can identify the involved parties based on the imprinted encryption value of the returned product.

Even if random hexadecimal numbers are imprinted on a counterfeit of a product of the retailer, for example, the retailer can judge whether the calculated encryption value has been issued from the retailer by referencing the issued encryption values database 40. If the imprinted encryption value does not collide with an issued encryption value, the product can be proven to be counterfeit.

When the message acquiring section 102 acquires information from the sender terminal 70 indicating that storage of the original message has been selected, the encryption calculating apparatus 30 generates the calculated encryption value and a security code for confirming access to the private webpage or the inheritance webpage. The encryption calculating apparatus 30 generates the security code 2500 by encrypting and compressing the calculation target message with the hash function. The encryption calculating apparatus 30 desirably generates the security code to be different from the calculated encryption value 2400.

The imprinting control section 106 controls the imprinting apparatus 90 that imprints the calculated encryption value onto the product as the imprinted encryption value, and also stores the imprinted encryption value in the issued encryption values database 40. When the message acquiring section 102 acquires information selecting storage of the original message or archiving data in the archive database 60, the imprinting control section 106 stores the imprinted encryption value 3010 in the issued encryption values database 40 and the archive database 60.

The media recording section 112 records, on the electronic medium, the original message acquired by the message acquiring section 102, the information identifying the calculation target message, and the security code output by the security code output section 108. The electronic medium is sent to the recipient along with the product on which the imprinted encryption value 3100 is imprinted.

The message receiving section 104 receives the confirming message input by the recipient or the inheritor. The encryption calculating apparatus 30 generates the confirming calculated encryption value based on the confirming message by using the hash function and the calculation function that converts the calculated hash values, which are specific to the retailer. The calculated encryption value output section 110 sends the confirming calculated encryption value to the recipient terminal 80 or terminal 85.

When the message acquiring section 102 acquires information indicating that the sender or the recipient wishes to access the private webpage that includes the archived data stored in the archive database 60, the access key receiving section 502 receives input of the access key for accessing the private webpage. The access key receiving section 502 receives the imprinted encryption value 3100 imprinted on the product as the access key. The security code receiving section 504 receives the security code 2500 from the recipient terminal 80 or the sender terminal 70.

When the specialized web server 50 creates the private webpage for handling communication between the sender and the recipient, the access key receiving section 502 receives the access key for accessing the private webpage. The security code receiving section 504 receives the security code from the recipient terminal 80 or the sender terminal 70. The authentication section 506 confirms access to the private webpage based on the received access key, the received security code, and the security code stored in the issued encryption values database 40.

The private webpage creating section 512 acquires the sender information and the recipient information stored in the archive database 60, based on the access key and the security code. The private webpage creating section 512 creates the private webpage based on the acquired sender information and recipient information. The private webpage output section 514 outputs the generated private webpage to the sender terminal 70 or the recipient terminal 80 that sent the security code. When there is input data from the sender terminal 70 or the recipient terminal 80 via the private webpage, the private webpage output section 514 stores this input data in the archive database 60.

The private webpage creating section 512 may include the access key in the URL (Uniform Resource Locator). The private webpage creating section 512 may specify the address of the file stored in the archive database 60 by the access key.

When a return message request is input by the recipient, the private webpage output section 514 sends the return message to the message acquiring section 102. In this case, the encryption calculating apparatus 30 generates a return calculated encryption value by using the hash function to compress at least a return calculation target message including text from the return message. The imprinting apparatus 90 may then imprint the return calculated encryption value on a return product sent to the sender as a return imprinted encryption value.

For example, the specialized web server 50 sets the storing period of the private website for the involved parties to be one year lasting from the time of creation, and during this storing period the sender and recipient may exchange messages by posting text, sound, images, photographs, videos, and the like. The specialized web server 50 sets the storing period to be the period during which the sender can receive the return message from the recipient via the private website.

The media recording section 112 may record the period during which a return message can be received on the private website on the electronic medium sent to the sender and the recipient. In this case, the security code output section 108 outputs this response-receiving period to the media recording section 112 based on the response-receiving period acquired from the sender terminal 70 by the message acquiring section 102. The message acquiring section 102 may acquire the information indicating that the sender wishes to create the private website along with the input indicating the response-receiving period from the sender terminal 70.

Since the general web server 10 informs the sender and the recipient that the response-receiving period is one year as described above, the sender knows that the recipient did not send a response if no response has been received during this period. The message acquiring section 102 may acquire instructions to extend the response-receiving period from the sender terminal 70. For example, if the sender wants to set the response-receiving period to be greater than one year, the message acquiring section 102 acquires instructions to extend the response-receiving period from the sender terminal 70. The message acquiring section 102 extends the response-receiving period stored in the archive database 60. By doing this, the waiting time of the sender is increased and the recipient receives a message that the sender is further waiting for a response from the recipient.

In this way, the text, sound, images, photographs, videos, and the like included in the return message from the recipient to the sender can be securely updated. Furthermore, the recipient can use the private webpage to repeatedly view and confirm the original message from the sender. By using the encryption calculating apparatus 30 to encrypt the message sent together with the product, the recipient can confirm the authenticity of the original message by confirming that the imprinted encryption value matches the calculated encryption value. The recipient can decipher the meaning of the imprinted encryption values to be the genuine message from the sender. The product manufacturing system 100 may further receive the product order with the message to be returned to the sender from the recipient terminal 80.

When the message acquiring section 102 acquires information indicating that the recipient, the sender, or the inheritor wishes to access the inheritance webpage that includes the archived data stored in the archive database 60, the access key receiving section 502 receives the imprinted encryption value as the access key to the inheritance webpage. The security code receiving section 504 receives the security code from the sender terminal 70, the recipient terminal 80, or the inheritor terminal 85.

The authentication section 506 acquires the authentication information including the imprinted encryption value from the archive database 60. The authentication section 506 verifies the access key and the security code with the authentication information, and then allows access to the inheritance webpage. The authentication section 506 also allows updating of the archived data based on the authentication process.

The inheritance webpage creating section 508 creates the inheritance webpage that includes the archived data. The inheritance webpage output section 510 outputs the created inheritance webpage to the sender terminal 70, the recipient terminal 80, or the inheritor terminal 85. The inheritance webpage output section 510 may receive information for adding postscripts from the inheritor terminal 85 to update the archived data in the archive database 60.

The retailer can grant access to the archived data based on the encryption value imprinted on the product, which is a portion of the access key, and the archived data can be data stored for ages on a computer and inherited from generation to generation, such as a family diary, a literary work, a family saying, a family tree, a voice message, a family photograph, an image, a video, and the like. By doing this, the access key to the archived data, a portion of which is the imprinted encryption value, can be confirmed for a descendent to inherit a product that lasts many years, such as jewelry. Therefore, a sense of togetherness is formed between the retailer and the descendents of the sender/recipient, so that the retailer can maintain customers of successive generations who do business with the retailer and hope for the continued success of the retailer. If the computer system of the retailer is further equipped with a redundancy system and disaster recovery measures, the information concerning the families of the involved parties can be securely archived for a long time, and the retailer can provide an archiving service to store family information for ages in a secure manner.

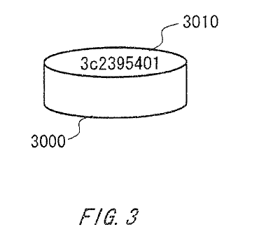

FIG. 3 is a schematic view showing the product on which the imprinted encryption value is imprinted. The product 3000 includes the imprinted encryption value 3010. The imprinted encryption value 3010 is a value obtained by compressing the calculation target message with the hash function, and is imprinted on the product 3000. For example, the imprinted encryption value is “3c2395401”.

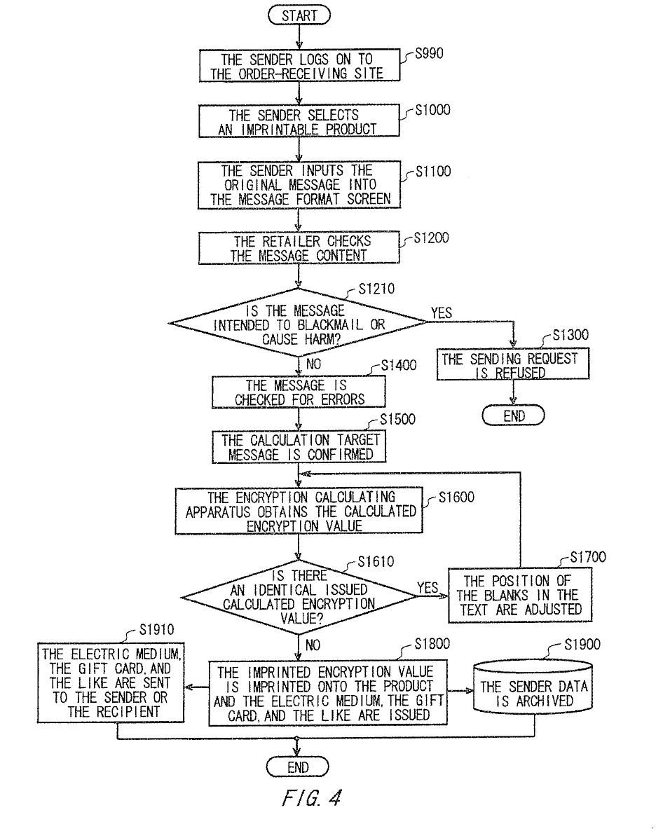

FIG. 4 is a flow chart of the process by which the calculated encryption value is imprinted on the product. When the sender presents the gift, the sender selects the product via the internet or the store staff, from a list of products provided by the retailer onto which the code can be imprinted. For example, the general web server 10 creates an order-receiving site to receive orders of the product from the sender terminal 70. The sender terminal 70 accesses the order-receiving site (step 990). The sender terminal 70 sends an input to the general web server 10 indicating a product selected by the sender onto which the calculated encryption value can be imprinted (step 1000).

Next, the sender passes the message data such as text, sound, and photographs that he/she wishes to associate with the product to the retailer or inputs this data in a “gift message receiving format” via the communication network 20 to be sent to the retailer. For example, the sender terminal 70 receives the information from the sender indicating the selected product together with the original message to be sent to the recipient, and sends both to the general web server 10 (step 1100).

The general web server 10 performs a personal confirmation to verify that the original message has been sent from the sender himself. The general web server 10 may have a personal confirmation section, not shown. The personal confirmation section issues an ID and password to the sender terminal 70 when the input selecting the product is received. The personal confirmation section may authenticate the generated ID and password when the original message is to be received. This authentication is to prevent the message associated with the gift from being misused for something other than the intended purpose.

After receiving the content of the original message, the message acquiring section 102 confirms the calculation target message and checks the content of the calculation target message (step 1200). More specifically, the retailer confirms that the original message received from the sender is not used to harm or threaten the recipient. If the calculation target message is intended to harm or blackmail the recipient, the message acquiring section 102 sends information to the sender terminal 70 indicating that the exchange is forbidden (step 1210). In this case, the general web server 10 does not begin the exchange with the sender (step 1300).

Since the product manufacturing system 100 uses a one-way hash function, it is possible that the message be misused to blackmail, harm, or compromise the integrity of the recipient because the original data cannot be reproduced from the imprinted encryption value itself. Accordingly, the retailer can receive consent from the customer that the giving of the gift cannot be used as blackmail or to cause harm, thereby earning the trust of the customer. This process is suitable for a retailer adopting the present embodiment, and the retailer can obtain consent from the customers in advance for the filtering described above when selling products using the present embodiment.

The message acquiring section 102 checks that the text of the calculation target message does not include an error value (step 1400). If the message acquiring section 102 detects an error value, it informs the sender terminal 70 of an error value with a suggested correction. When consent for the correction is received from the sender terminal 70, the message acquiring section 102 corrects the text. By doing this, the message acquiring section 102 confirms the calculation target message that will be encrypted (step 1500).

The message acquiring section 102 receives information from the sender terminal 70 selecting whether to create the private webpage or the inheritance webpage, via the specialized web server 50. More specifically, the message acquiring section 102 acquires information from the sender terminal 70 indicating whether to store the original message in the archive database 60. After acquiring the information selecting creation of the private webpage or the inheritance webpage, the message acquiring section 102 receives input from the sender terminal 70 concerning a payment method and the period for providing the private webpage or the inheritance webpage.

After acquiring the information selecting creation of the private webpage or the inheritance webpage, the message acquiring section 102 stores the determined original message and the information identifying the calculation target message in the archive database 60. When the message acquiring section 102 receives a request for archiving other data from the sender terminal 70, it stores this data in the archive database 60.

The message acquiring section 102 also acquires information selecting an optional product, such as a gift card or a gift plaque on which the message is written, and customer order information indicating the payment method, a delivery address, a shipping method, a storing period, the price, and the like. The message acquiring section 102 acquires the customer information of the sender and the recipient as the sender information, and stores this sender information in a storage apparatus, not shown. After acquiring the information selecting creation of the private webpage or the inheritance webpage, the message acquiring section 102 stores the sender information and the recipient information in the archive database 60.

The encryption calculating apparatus 30 uses the hash function to encrypt and compress the calculation target message, which includes at least text, thereby generating the calculated encryption value (step 1600).

When the encryption calculating apparatus 30 encrypts the calculation target message, it is desirable to avoid generating a calculated encryption value that happens to be identical to the calculated encryption value of the very same calculation target message from a different sender. To avoid this problem, the retailer recommends choosing unique text. For example, the retailer recommends adding a character string indicating the date that the gift is given.

The retailer confirms the calculation target message by determining the file and the file-type included as the encryption target based on a discussion with the sender. By using the hash function for encryption, the encryption calculating apparatus 30 can obtain each hash value from each file such as digitized text, sound, images, and videos, as shown in FIG. 9. When considering the effort exerted by the involved parties when verifying the imprinted encryption value, however, the retailer desirably recommends that the text be set as the calculation target.

If a calculated encryption value that is identical to the calculated encryption value generated by the encryption calculating apparatus 30 is already stored in the issued encryption values database (step 1610), the encryption calculating apparatus 30 changes or adds/subtracts the blank positions of the text included in the calculation target message. The encryption calculating apparatus 30 generates a calculation target message for generating a final calculated encryption value that is different from all of the issued imprinted encryption values, and fixes the generated calculated encryption value (step 1700).

When the message acquiring section 102 receives the information selecting creation of the private webpage from the sender terminal 70, the encryption calculating apparatus 30 generates the calculated encryption value and the security code for accessing the private website. The encryption calculating apparatus 30 sends the security code to the security code output section 108. The imprinting control section 106 stores the calculated encryption value in the issued encryption values database 40 and the archive database 60.

After receiving the original message and the information identifying the calculation target message from the message acquiring section 102, the media recording section 112 records this information on the electronic medium 3100. After receiving the security code from the security code output section 108, the media recording section 112 records the security code on the electronic medium 3100. The media recording section 112 may also record a password, ID, and access method for accessing the specialized web server 50. The retailer may record the security code, password, ID, and access method for accessing the specialized web server 50 into a guide book, and give this guide book to the sender and the recipient.

When the message acquiring section 102 receives information from the sender terminal 70 selecting not to create the private webpage or the inheritance webpage, the imprinting control section 106 stores the sender and the recipient information together with the calculated encryption value in the issued encryption values database 40. By doing this, future problems of repeatedly issuing the same imprinted encryption value can be avoided and the sender and/or the recipient can be contacted if a lost product is returned.

The product 3000, the electronic medium on which the original message is recorded 3100, the optional gift card, and/or the optional gift plaque 3200 are delivered to the recipient as a gift set or are passed directly from the sender to the recipient after being delivered to the sender (step 1910). The method for connecting the sender terminal 70 or the recipient terminal 80 to the general web server 10 as the encoding system of the retailer is provided to the recipient along with the gift set. When accessing the encryption calculating apparatus 30 via the general web server 10, the sender terminal 70 or the recipient terminal 80 can be used to input information concerning the imprinted encryption value of the product, the date the gift is given, the name of the sender, and the like. The general web server 10 may then authenticate the input information with the information recorded in the storage apparatus, not shown, to allow access to the encryption calculating apparatus 30. By doing this, the retailer can prevent manufacturing of counterfeits.

After acquiring the information selecting creation of the private webpage or the inheritance webpage from the sender terminal 70, the message acquiring section 102 acquires the archiving data from the sender. The message acquiring section 102 stores the archiving data together with the original message in the archive database 60 (step 1900).

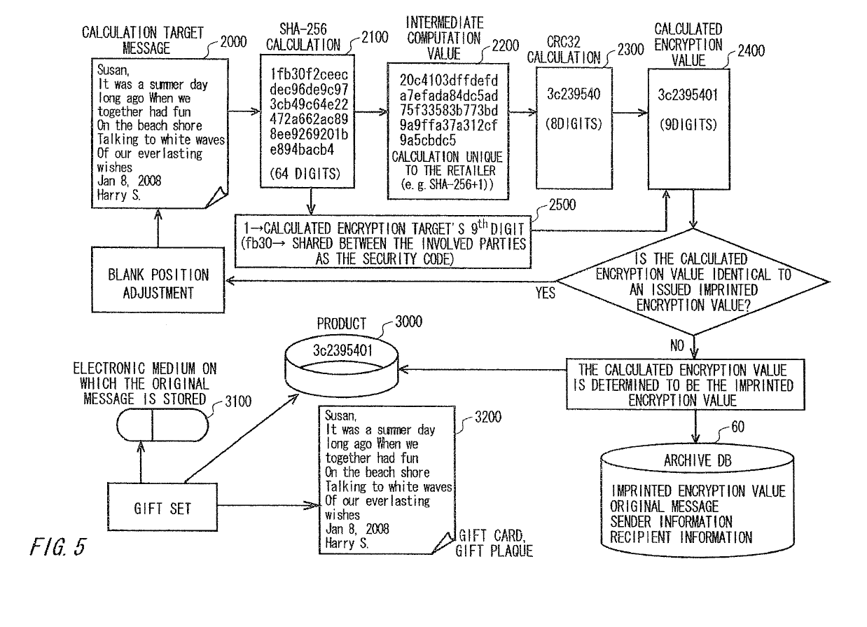

FIG. 5 is a schematic view showing generation of the encryption from the calculation target message. The encryption calculating apparatus 30 encrypts and compresses the calculation target message 2000 into a first hash value 2100, having 64 digits of hexadecimal values, using a hash function SHA-256, for example. The encryption calculating apparatus 30 adds one to each hexadecimal value in the first hash value 2100 according to the function specific to each retailer, while keeping each digit as a single digit, to generate the intermediate calculation value 2200. The function specific to each retailer may be any type of function and may be specific to each product manufacturing system.

The encryption calculating apparatus 30 performs a hash function CRC32 (Cyclic Redundancy Check 32) on the intermediate calculation value 2200 to create an 8-digit second hash value 2300. The encryption calculating apparatus 30 attaches the first digit of the first hash value 2100 to the second hash value 2300 as the ninth digit 2500 of the calculated encryption value, thereby generating the final calculated encryption value 2400 having a total of 9 digits. The operation of the encryption calculating apparatus 30 is not limited to this, and the encryption calculating apparatus 30 may use any combination of functions that compress and/or encrypt using the hash function.

The probability of a hash collision, that is, the chance that the 9-digit hexadecimal hash calculation value described above is the same as a hash calculation value resulting from different original data, is one in 16⁹, which is one in 68,719,476,736. If we assume that the number of imprinted encryption values issued is approximately 100,000 per year, there would be a total of 10 million imprinted encryption values issued in 100 years, so that the hash collision probability in the 101^{st} year would be approximately 0.0146%. Accordingly, of the 100,000 imprinted encryption values issued during the 101^{st} year, approximately 14.6 of the calculated encryption target messages are expected to cause hash collisions. Since the hash collision probability during the first year is 0.000146%, approximately 0.146 of the 100,000 imprinted encryption values issued during the first year are expected to cause hash collisions.

In order for the encryption calculating apparatus 30 to generate a calculated encryption value that is different from previously generated calculated encryption value, the encryption calculating apparatus 30 adjusts the calculation target message that is based on the original message acquired from the sender terminal. When adjusting the calculation target message, the encryption calculating apparatus 30 generates the calculated encryption value after adjusting the position of the blanks in the calculation target message. The encryption calculating apparatus 30 sets the security code to be the four hexadecimal values 2500 from the second digit through the fifth digit in the SHA-256 calculation result.

The security code increases security by blocking access by a third party and strengthening the verifiability of the original message. The sender, the recipient, and the retailer are aware of a method for finding the security code if one of the involved parties forgets the security code. By setting the four values in the SHA-256 calculated encryption value 2100 as the security code, the ability to confirm the authenticity of the original message is increased by 16⁴ times.

The encryption calculating apparatus 30 can increase the number of digits in the imprinted encryption value. For example, the encryption calculating apparatus 30 can easily increase the number of digits by choosing a new digit to include from among the SHA-256 calculated encryption value 2100 of the calculation target message, thereby decreasing the probability of a hash collision.

The media recording section 112 records the original message and the information identifying the calculation target message on the electronic medium 3100. The electronic medium 3100 and the gift card/gift plaque 3200 are provided to the sender and the recipient as options included with the product 3000.

The message receiving section 104 acquires from the sender terminal 70, the recipient terminal 80, or the inheritor terminal 85, a manually input message or a copy of the calculation target message recorded on the electronic medium 3100 as a confirming message. The encryption calculating apparatus 30 obtains the confirming calculated encryption value based on the acquired confirming message and outputs the confirming calculated encryption value to the calculated encryption value output section 110. The sender, the recipient, or the inheritor can authenticate the confirming message by verifying that the-confirming calculated encryption value is the same as the imprinted encryption value.

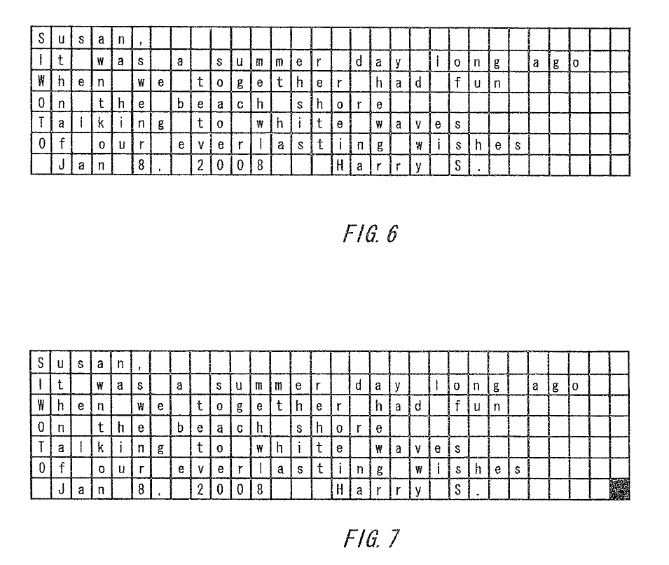

FIG. 6 shows an example of calculation target message included in an original message. The encryption calculating apparatus 30 obtains the result shown in Table 1 by using the hash function SHA-256 on the calculation target message of FIG. 6.

TABLE 1

1fb30f2ceecdec96de9c973cb49c64e22472a662ac898ee9269201be894bacb4

The encryption calculating apparatus 30 adds one to each digit of the hash function SHA-256 calculation result shown above to obtain the calculation result, as the intermediate computation value, shown in Table 2.

TABLE 2
20c4103dffdefda7efada84dc5ad75f33583b773bd9a9ffa37a312cf9a5cbdc5

The encryption calculating apparatus 30 obtains the calculation result “3c239540” through the hash function CRC32. The encryption calculating apparatus 30 obtains “3c2395401” as the calculated encryption value. The encryption calculating apparatus 30 obtains “fb30” as the security code.

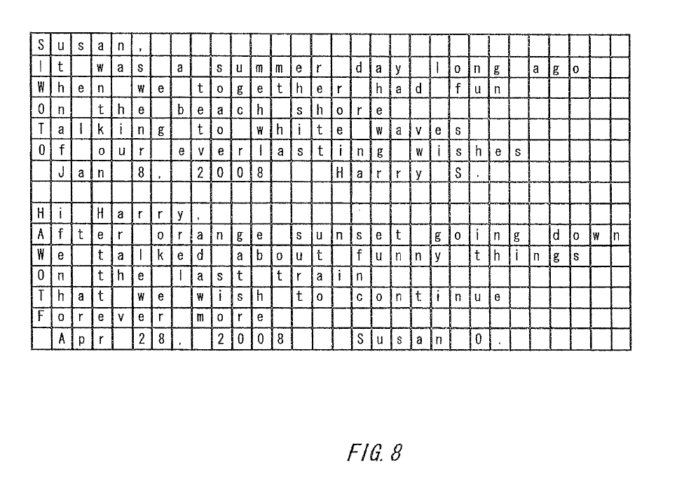

FIG. 7 shows an example in which the blanks in the first message are changed. The encryption calculating apparatus 30 obtains the result shown in Table 3 by using the hash function SHA-256 on the calculation target message of FIG. 7.

TABLE 3

9d8e0b7686f72fd0c55a5c0de0c5dc7cc436583e5f1040caa7d9d005a54b526b

The encryption calculating apparatus 30 adds one to each digit of the hash function SHA-256 calculation result shown above to obtain the calculation result, as the intermediate computation value, shown in Table 4.

TABLE 4

ae9f1c87970830e1d66b6d1ef1d6ed8dd547694f602151dbb8eae116b65c637c

The encryption calculating apparatus 30 obtains the calculation result “69f96efc” through the hash function CRC32. The encryption calculating apparatus 30 obtains “69f96efc9” as the calculated encryption value. The encryption calculating apparatus 30 obtains “d8e0” as the security code.

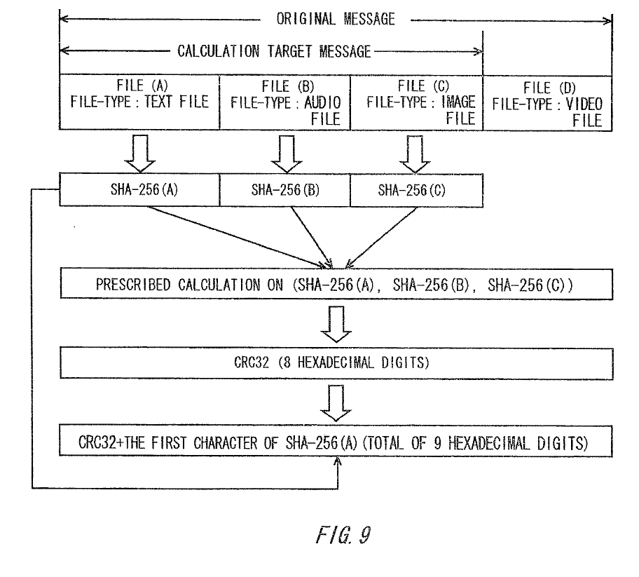

FIG. 8 shows an example of return message sent from the recipient to the sender. The encryption calculating apparatus 30 obtains the result shown in Table 5 by using the hash function SHA-256 on the calculation target message of FIG. 8.

TABLE 5

2d1817a1160583d5ac3c2c7c6d6f3cbd1b481d6d6d841e86a555747a0d6f8f01

The encryption calculating apparatus 30 adds one to each digit of the hash function SHA-256 calculation result shown above to obtain the calculation result, as the intermediate computation value, shown in Table 6.

TABLE 6

3e2928b2271694e6bd4d3d8d7e704dce2c592e7e7e952f97b666858b1e709012

The encryption calculating apparatus 30 obtains the calculation result “d822597c” through the hash function CRC32. The encryption calculating apparatus 30 obtains “d822597c2” as the calculated encryption value.

FIG. 9 shows an example of a process performed by the encryption calculating apparatus 30 when encrypting files having file-types different from each other. When obtaining the calculated encryption value from the plurality of files, the encryption calculating apparatus 30 encrypts each file with the hash function SHA-256 to obtain a first hash value for each file. The encryption calculating apparatus 30 then combines each of the first hash values in order to obtain a second hash value as the calculated encryption value.

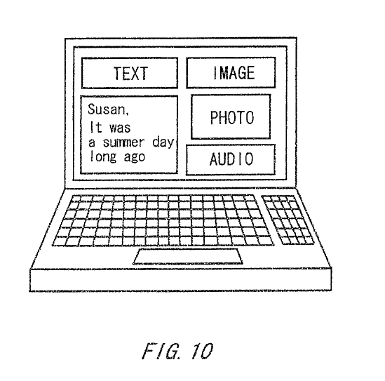

FIG. 10 shows an exemplary display screen for displaying the private webpage or the inheritance webpage. The specialized web server 50 provides text, images, sound, and the like to be selectable by the sender terminal 70 and the recipient terminal 80.

When a product is selected from the recipient terminal 80 to be sent back to the sender along with a response, the general web server 10 may generate the calculated encryption value by combining the response and the message from the sender stored in the archive database 60. By doing this, the sender and recipient can share both messages between them, thereby increasing the feeling of togetherness.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

1. A method for manufacturing a product that involves encrypting at least a portion of an original message given from a sender to recipient associated with the product and imprinting the encrypted value onto the product, the method being performed by a product manufacturing system and comprising the steps of:
(a) acquiring the original message, by a means of a message acquiring section in the product manufacturing system;
(b) setting at least a portion of the original message to be a calculation target message and acquiring a calculated encryption value by compressing the calculation target message with a hash function, by means of an encryption calculating apparatus in the product manufacturing system; and
(c) imprinting the calculated encryption value onto the product as an imprinted encryption value, by means of an imprinting apparatus in the product manufacturing system.

2. The method according to claim 1, wherein the step (b) includes:
calculating a hash value from the calculation target message, by means of the encryption calculating apparatus;
obtaining an intermediate calculation value by performing an arbitrary function calculation on the hash value, by means of the encryption calculating apparatus; and
calculating the calculated encryption value from the intermediate calculation value, by means of the encryption calculating apparatus.

3. The method according to claim 1, further comprising the steps of:
(d) receiving, by means of a message receiving section in the product manufacturing system, the calculating target message that is at least a portion of the original message sent together with the product, as a confirming message input by the recipient or an inheritor who will inherit the product; and
(e) outputting a confirming calculated encryption value that is identical to the imprinted encryption value, if the confirming message is identical to the calculation target message, by means of the encryption calculating apparatus.

4. The method according to claim 2, further comprising the steps of:
(f) creating a private webpage for receiving an exchange between the sender and the recipient, by means of a private webpage creating section in the product manufacturing system;
(g) outputting a security code that is generated from a calculation result of the step of calculating a hash value and that is different from the calculated encryption value, for verifying an access right to the created private webpage, by means of a security code output section in the product manufacturing system;
(h) receiving, from the sender or the recipient, the security code sent together with the product, by means of a security code receiving section in the product manufacturing system; and
(i) verifying the access right to the private webpage based on the received security code, by means of an authentication section in the product manufacturing system.

5. The method according to claim 2, further comprising the steps of:
(j) archiving data that the sender, the recipient and the inheritor wish to store, by means of the message acquiring section in the product manufacturing system;
(k) creating an inheritance webpage that includes the archived data for each of the sender, the recipient, and the inheritor, by means of an inheritance webpage creating section in the product manufacturing system;
(l) receiving input of an access key for accessing the inheritance webpage, by means of an access key receiving section in the product manufacturing system;
(m) outputting a security code that is generated from a calculation result of the step of calculating a hash value and that is different from the calculated encryption value, for verifying an access right to the created inheritance webpage, by means of a security code output section in the product manufacturing system;
(n) receiving, from the sender, the recipient, and the inheritor, the security code sent together with the product, by means of a security code receiving section in the product manufacturing system; and
(o) verifying the access key with authentication information including the calculated encryption value, based on the received security code, and allowing access to the inheritance webpage and also allowing the archived data to be changed, by means of an authentication section in the product manufacturing system.

6. A product manufacturing system that encrypts at least a portion of an original message given from a sender to a recipient associated with a product and imprints the encrypted value onto the product, comprising:
message acquiring section that acquires the original message;
a calculation encryption processing section that sets at least a portion of the original message to be a calculation target message and acquires a calculated encryption value by compressing the calculation target message with a hash function; and
an imprinting apparatus that imprints the calculated encryption value onto the product as an imprinted encryption value.

7. A product that is sent from a sender to a recipient and on which is imprinted an imprinted encryption value obtained by encrypting, with a hash function, at least a portion of an original message given from the sender to the recipient associated with the product.

8. The method according to claim 2, further comprising the steps of:
(d) receiving, by means of a message receiving section in the product manufacturing system, the calculating target message that is at least a portion of the original message sent together with the product, as a confirming message input by the recipient or an inheritor who will inherit the product; and
(e) outputting a confirming calculated encryption value that is identical to the imprinted encryption value, if the confirming message is identical to the calculation target message, by means of the encryption calculating apparatus.
